(19) United States
(12) Patent Application Publication
(10) Pub. No.: US 2014/0073384 A1
(43) Pub. Date: Mar. 13, 2014

(54) Quiz Game Show Methods and Apparatus

(71) Applicant: Artases OIKONOMIDIS, Moscow (RU)

(72) Inventor: Artases OIKONOMIDIS, Moscow (RU)

(21) Appl. No.: 13/609,261

(22) Filed: Sep. 11, 2012

(51) Int. Cl. A63F 13/00; A63F 13/12; A63F 13/10

(52) U.S. Cl. 463/9

(57) ABSTRACT

Technical features described in this application can be used to construct various embodiments of television quiz show gaming methods and apparatus, according to the embodiments described herein. In one approach, a method of television quiz show gaming utilizes a television quiz game show controller to control a quiz question and answer game play on player devices of a plurality of players. Sudoku game play for selecting one or more players to enter or continue play in the television question and answer quiz show is also controlled on at least some of said player devices by the controller. According to the outcome of the Sudoku game play on said player devices, the controller selects one or more players for entering or continuing in the television quiz question and answer game show.

A portion of the disclosure of this patent document contains material which is subject to copyright protection. The copyright owner has no objection to the facsimile reproduction by any-one of the patent document or the patent disclosure, as it appears in the Patent and Trademark Office patent file or records, but otherwise reserves all copyright rights whatsoever.

### TECHNICAL FIELD

The present invention relates to game show methods and apparatus. More specifically, the invention relates to television quiz game show methods and apparatus.

### BACKGROUND

In general, knowledge quiz game show contestants play a game in which they answer questions for monetary rewards or other types of prizes. The general knowledge quiz questions may be on the same or different topics such as art, literature, science, popular culture, sports and so on.

There is a need to provide improved quiz game show methods and apparatus.

### SUMMARY

According to one aspect, there is provided a television quiz game show method. The method may comprise a method of television quiz show gaming that comprises controlling, utilizing a television quiz game show controller device, a television quiz question and answer game play on player devices of a plurality of players; controlling, utilizing said game show controller device, at least one Sudoku game play on at least some of said player devices; and selecting, utilizing said game show controller device, at least one player from among said plurality of players for entering or continuing to play in said television quiz question and answer game show, according to the outcome of said Sudoku game play on said player devices.

According to another aspect, there is provided a television quiz game show apparatus. The apparatus may comprise a processor operably connectable to a plurality of player devices, a data bus coupled to said processor, and a computer-usable medium embodying computer program code; said computer-usable medium being coupled to said data bus and said computer program code comprising instructions executable by said processor and configured to: control a television quiz question and answer game play on player devices of a plurality of players, control at least one Sudoku game play on at least some of said player devices, and select at least one player from among said plurality of players for entering or continuing to play in said television quiz question and answer game show, according to the outcome of said Sudoku game play on said player devices.

According to yet another aspect, there is provided a computer-readable medium for a television quiz game show; the computer-readable medium embodying computer program code; the computer program code comprising computer executable instructions configured for controlling, utilizing a television quiz game show controller device, a television quiz question and answer game play on player devices of a plurality of players; controlling, utilizing said game show controller device, at least one Sudoku game play on at least some of said player devices; and selecting, utilizing said game show controller device, at least one player from among said plurality of players for entering or continuing to play in said television quiz question and answer game show, according to the outcome of said Sudoku game play on said player devices.

According to still another aspect, there is provided an internet quiz game show method. The method may comprise a method of internet quiz show gaming that comprises controlling, utilizing an internet quiz game show controller device, an internet quiz question and answer game play on player devices of a plurality of players; controlling, utilizing said game show controller device, at least one Sudoku game play on at least some of said player devices; and selecting, utilizing said game show controller device, at least one player from among said plurality of players for entering or continuing to play in said internet quiz question and answer game show, according to the outcome of said Sudoku game play on said player devices.

### BRIEF DESCRIPTION OF THE DRAWINGS

In order that the present invention may be more readily understood, reference will now be made to the accompanying drawings, in which:

FIG. 1 is a schematic of an exemplary television studio and data processing environment for implementing television quiz game show methods, according to one embodiment;

FIG. 2A is a schematic of an exemplary game show server for implementing quiz game show methods, according to one embodiment;

FIG. 2B is a schematic of an exemplary quiz game show player/presenter user device for implementing quiz game show methods according to one embodiment;

FIG. 3 is a flow chart illustrating an exemplary method of television quiz show gaming implemented in the TV studio and data processing environment of FIG. 1, according to one embodiment;

FIG. 4 illustrates a block diagram of exemplary software modules of the television quiz game show data processing system, implemented as a client-server application, according to one embodiment;

FIG. 5 illustrates a block diagram showing in more detail the exemplary player entrant selector 402 of FIG. 4, according to one embodiment;

FIG. 6 illustrates a block diagram showing in more detail the exemplary team leader selector 408 of FIG. 4, according to one embodiment;

FIG. 7 illustrates a block diagram showing in more detail the exemplary game show finalist selector 409 of FIG. 4, according to one embodiment;

FIG. 8 is a schematic of an exemplary data processing network environment in which methods of internet quiz show gaming may be implemented, according to one embodiment;

FIG. 9 is a schematic of a screen shot of an exemplary Sudoku play user interface for player entrant selection, according to one embodiment;

FIG. 10 is a schematic of a screen shot of an exemplary question and answer play user interface for qualifying teams and awarding team prizes; and

FIG. 11 is a schematic of a screen shot of an exemplary finalist question and answer play user interface for playing to win the final prize.

### DETAILED DESCRIPTION

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Technical features described in this application can be used to construct various embodiments of television quiz show gaming methods and apparatus, according to the embodiments described herein. In one approach, a method of television quiz show gaming utilizes a television quiz game show controller to control a quiz question and answer game play on player devices of a plurality of players. Sudoku game play for selecting one or more players to enter or continue play in the television question and answer quiz show is also controlled on at least some of said player devices by the controller. According to the outcome of the Sudoku game play on said player devices, the controller selects one or more players for entering or continuing in the television quiz question and answer game show.

Sudoku is a game in which the puzzle solution is a 9×9 grid (or other n×n grid) of digits in the form of a Latin square where each column, row and sub-grid (also known as boxes, blocks, regions or sub-squares) that compose the grid contain all the digits from 1 to 9 exactly once. Further rules are applied to the game that limits which digits can be placed where in the grid.

According to another approach, the broadcasting/recording of Sudoku game play on studio player devices for selecting a player in the television question and answer quiz game show can be substantially synchronized with Sudoku game play on user devices for selecting one or more players for entering another television question and answer quiz game in the future. In one approach, Sudoku game play provided on studio player devices for selecting a player in the television question and answer quiz game show can also be provided on one or more remote and/or audience user devices to enable remote and/or audience users to compete with the studio players for a prize.

According to yet another approach, a method of internet quiz gaming is provided that implements the aforementioned television game show method over the internet rather than in the TV studio.

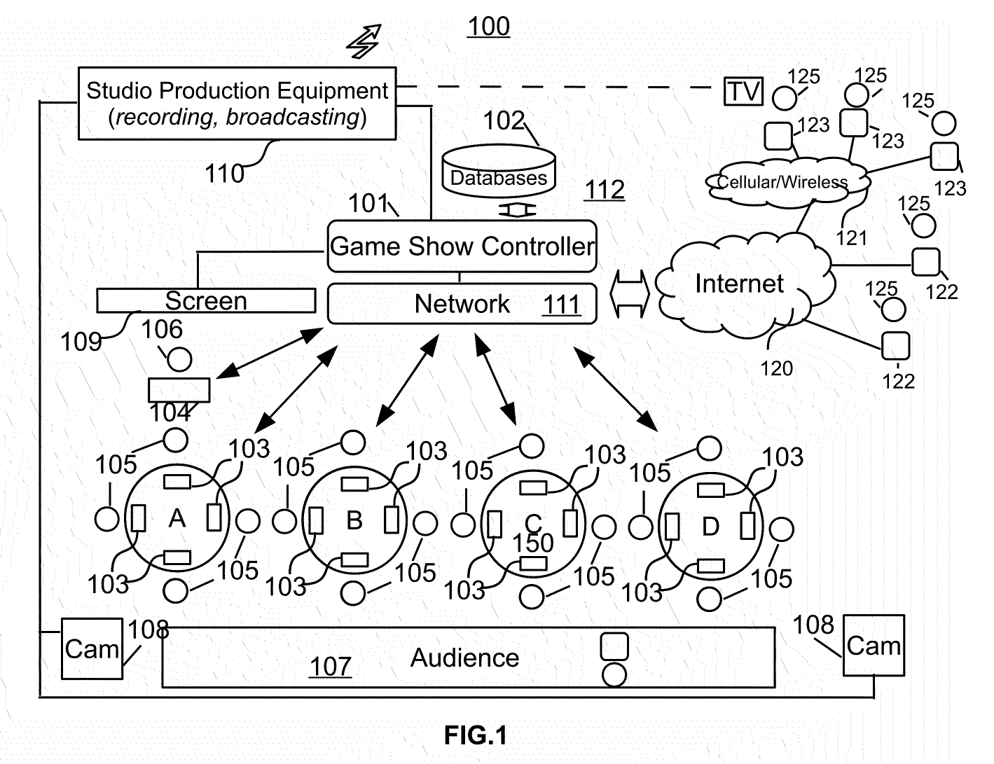

FIG. 1 of the accompany diagrams is a schematic of an exemplary television studio and data processing environment 100 for implementing television quiz game show methods, according to one embodiment. The television studio has studio production equipment 110 for recording and broadcasting the quiz game show. A television game show data processing system 112 is provided for implementing the television quiz game show on any one or a combination of studio player devices 103, studio presenter devices 104 and user devices 122 and 123. The television game show data processing system has a game show controller device 101 that is operably connected to a plurality of studio player devices 103 and one or more game show presenter devices 104. In FIG. 1 the game show controller device 101 is local to the TV studio. In other embodiments, the controller device 101 may be remotely located from the TV studio.

Game show controller device 101 is operably connected by wire or wireless connection to the plurality of studio player devices 103 through network 111 so that game show players 105 can interface with game play controlled by the game show device 101. The network 111, to which the game show server 101 is connected, is a local area network (LAN), but equally can be any one or a combination of, or an interconnection, and is not restricted to a local area network (LAN), a wide area network (WAN), such as the internet, an office network; or a wireless telecommunication network.

In the non-limiting example of FIG. 1, the television studio and data processing environment 100 includes internet network 120 or other wide area networks and/or wireless/cellular network 121 for internetworking user devices 122 and 123 (remotely located from the TV studio) to the television game show controller device 101, such that one or more user devices 122 and 123 may interface with users 125 (remotely located from the TV studio) via the game play controller device for the purpose of game show registration, entrant selection and/or game play.

Game show controller device 101 is also operably connected via network 111 to one or more display screens 109 for displaying game play to television studio recording cameras 108 and studio audience 107. Device 101 is also operably connected, e.g. via wire or wireless connection, to one or more presenter devices 104 for allowing a person 106 presenting the television game show to view and coordinate game play on the player devices 103. Parts or all of the television show game play interfaces provided on the devices can be provided electronically by the controller device to the studio equipment for recording/broadcasting, in addition to or instead of displaying on the studio screen 109. In other examples, any one or combination of the player devices, presenter device(s) and studio screen(s) may be connected directly to the game show controller device, rather than through the network 111. Also, in other examples, studio screen(s) 109 may be omitted.

Presenter device 104 may alternatively be a fully automated device such that the device, rather than the person, presents the entire television show to the studio cameras and audience via the studio screens or directly to the studio broadcasting/recording equipment. In such an example, the presenter device may be integrated in the controller device itself, as desired.

One example of the game show controller device 101 of FIG. 1 is a game show server that implements television quiz game show software in client-server architecture for running the television game quiz gaming methods, as will be explained in more detail below. In various other embodiments, the game show software can be implemented as a client or as a server, rather than both as client and server. In other embodiments, other architecture is envisaged for implementing the game show software, such as peer-to-peer architecture.

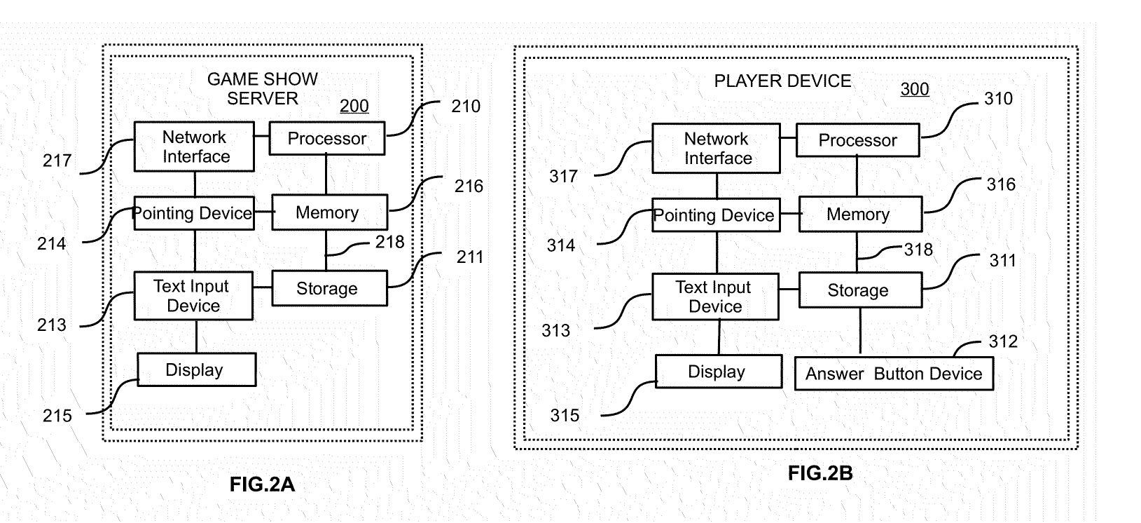

By way of example, game show controller device 101 may be a game show server having a general hardware configuration for example, shown in, but not limited to FIG. 2A. Game show server 200 has a central processor unit (CPU) or other processor 210, operable to execute one or more programs, including the game show application module under the control of program software provided in memory 216, such as random access memory (RAM), and also in a storage memory 211, such as a disc drive. The storage memory 211 and the memory 216 are also available to the processor unit 210 as temporary or permanent storage of results and data. A network interface 217 is coupled to the processor unit 210 and permits communication between the processor unit 210 and local and/or external network devices over network 111. One or more data buses interconnect the game show server 200 components shown in FIG. 2A

Processor unit 210 is coupled to receive input from one or more input devices that may be, but not limited to, a pointing device 214, such as a mouse, pad or touch screen and a text input device 213, such as a keyboard or touch screen. Other input devices capable of receiving human-entered input selections for locally setting up and operating the game server user can be adopted, in addition or in place of devices 213 and 214. The processor unit 210 also drives a display 215 that displays images and provides sounds, as controlled and provided by the processor unit 210. Alternatively, one or more of the input devices 213-215 may be omitted and the server can be set up via remotely-connected devices.

Referring now to the studio player devices 103 and studio presenter device 104 of FIG. 1, theses are computerized devices having a general hardware configuration for example, shown in, but not limited to, FIG. 2B. Each player/presenter device has a processor unit 310, memory 316, storage 311, display 315, network interface 317 and input devices, such as pointing device 314, text input device 313 and answer buzzer device 312. These components are interconnected via data bus connections 318. The Central processor unit (CPU) or other processor 310 is operable to execute one or more programs, including a client-user application module under the control of program software provided in memory 316, such as random access memory (RAM), or in a storage memory 311, such as a disc drive. The storage memory 311 and the memory 316 are also available to the processor unit 310 as temporary or permanent storage of results and data. Network interface 317 is coupled to the processor unit 310 and permits communication between the processor unit 310 and the game server and with other player/presenter devices over network 111.

In the example of FIG. 1, the player devices 103 and presenter device 104 are computer terminals but, alternatively, may be any one or a combination of computers, tablets, smart phones, or other types of computerized devices capable of performing the functionality of the player devices/presenter devices of the embodiments described herein.

Remote user devices 123 and 125 may be any one or combination of home computers, office computers, smartphones, tablets and other computerized devices. Remote user devices 123 and 124 may have hardware configurations along the lines of the local studio player devices 103/presenter devices 104 but, generally, do not include customized game show hardware input devices, such as a buzzer device.

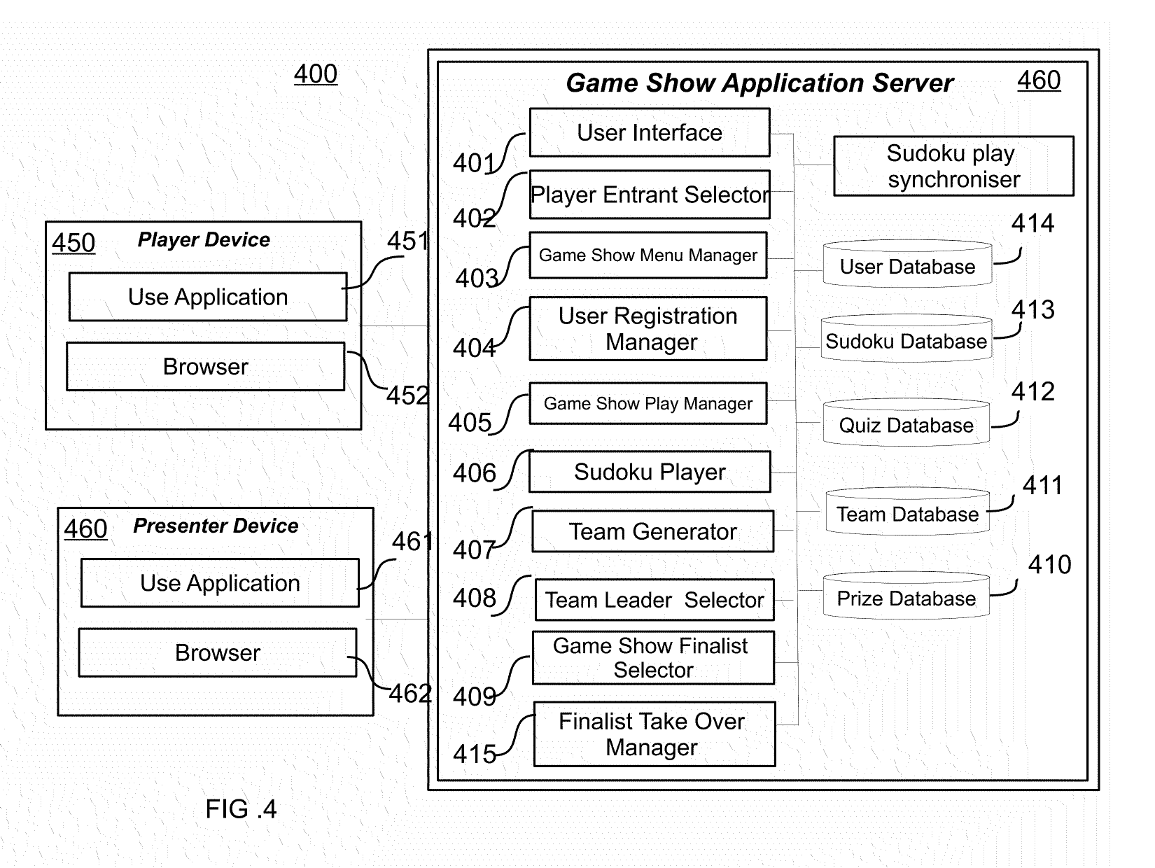

Attention is next drawn to FIG. 4, an exemplary block diagram illustrating the computer software system 400 for directing the operation of the television game show data processing systems of the embodiments. Software system 400 has a game show application module which is stored in system storage/memory. The software system can include a kernel or operating system and a shell or interface. One or more application programs or modules, such as the game show application module, may be “loaded” (i.e. transferred from storage into memory for execution by the processor). The system receives user commands and data through user interface; these inputs may then be acted upon by the game show server, in accordance with instructions from operating module and/or application module.

Note that the term “module” as used herein may refer to a collection of routines and data structures that perform a particular task or implements a particular abstract data type. Modules may be composed of two parts: 1) an interface that lists the constants, data types, variable, and routines that can be accessed by other modules or routines and 2) an implementation that is typically private, accessible only to that module, and includes source code that actually implements the routines in the module. The term “module” may also simply refer to an application, such as a computer program design, to assist in the performance of a specific task.

Application game show modules can include instructions, such as the various computer implemented operations described herein. More specifically, in one example as shown in FIG. 4, application game modules can include a user interface 401, player entrant selector module 402, game show menu manager module 403, user registration manager module 404, game show play manager module 405, Sudoku player module 406, team generator module 407, team leader selector module 408, game show finalist selector module 409, and finalist take over manager module (415). In one non-limiting embodiment, a television studio broadcasting-game show synchronization module, player device software 450, is also provided on the game server.

The software system can include databases, libraries, and other indexes or searchable data storage systems for storing data, including, for example, user profile data, administration data and authentication data. Such databases and other storage systems can be stored in storage/memory which can be located locally or remotely from the processor. In the example of FIG. 4, the software system 400 also includes user databases, libraries and/or other storage systems that store data associated with the system. In particular, the software system has a prize database 410, team database 411, quiz database 412, Sudoku database 413, and user database 414.

Prize database 410 includes data relating to prizes awarded to game players according to particular game play. Team database 411 includes data about teams and team players for use by the game show play manager 405 in game show execution. Quiz database 412 includes data on game show general knowledge questions and answers for providing quiz show play on player devices for players to answer. Sudoku database 413 includes data on Sudoku puzzle templates and Sudoku solutions for use in providing Sudoku game play on player devices. User database 414 includes data relating to user registration details, including applicant details, player entrant details and television host/presenter details, etc.

Software system 400 also includes player device software system 450 and presenter device software system 460. Player device software system 450 is loadable on each studio player device 103 and has a user application module 451 and browser 452 module that enables the server to provide game play on the devices. The player device software system 450 may also be loadable on remote user devices 122 and 123. Presenter device software system 460 is loadable on the game show presenter device 104 and has a user application module 461 and browser module 462. Software systems for the remote user devices are the same or generally similar to those for the studio player devices and adaptable to suit the particular user device configuration, e.g. smart phone, tablet, etc.

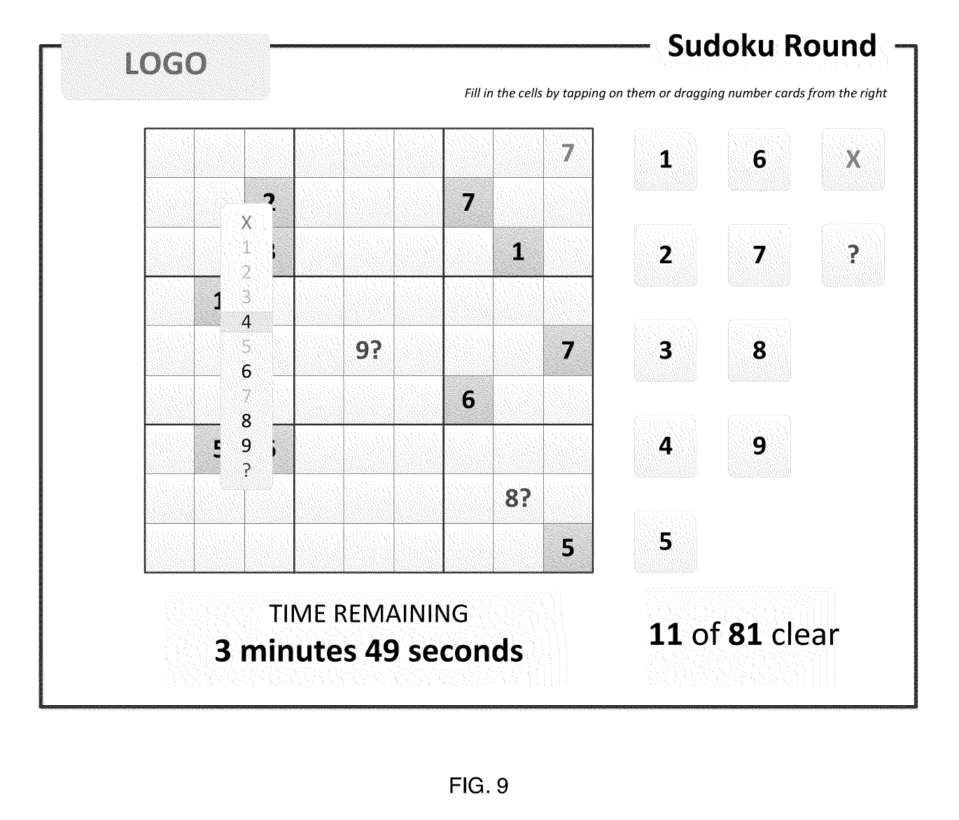

User interface module 401 is configured to enable the game show server to provide individually adapted player interfaces on the studio player devices and any remote devices through user applications 451 running on the devices. Non-limiting examples of player device display screen shots of the play user interfaces are shown in FIGS. 9-11 In one non-limiting example, the play user interface is implemented as an interactive Web page that is provided by the game show application server to the player device 105 for display through a Web browser.

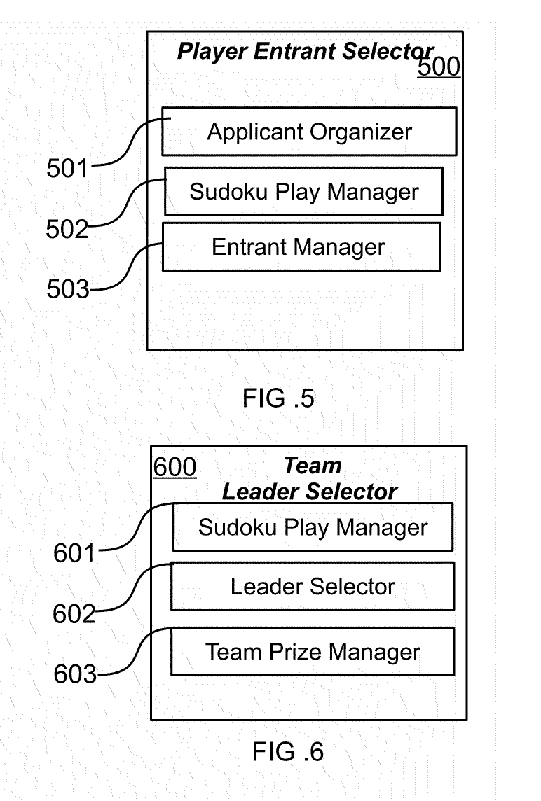

One example of the player entrant selector module 402 is shown in FIG. 5. Player entrant selector module 500 has an applicant organizer 501, a Sudoku play manager 502, and a player entrant manager 503. Applicant organizer 501 is configured to arrange into manageable groups applicants that have registered applications for entry into the TV game show. Sudoku play manager 502 is configured to manage Sudoku play on devices of a group of the applicants. Player entrant manager 503 is configured to select a group of player entrants, according to the outcome of the Sudoku game play on the devices of the group of applicants.

Game show menu manager module 403 is configured to provide game menus to the presenter device 104 and player devices 103 for facilitating game play set up and user registration, etc.

User registration manager module 404 is configured to provide registration and user login capability to the player, presenter and user devices for enabling user registration and access to the game show play through the user applications. User registration manager module 404 is also configured to register and control access according to game show participant status, e.g. TV game show applicants, TV game show entrants, players of the TV game show, team players and the TV game show presenter/hosts, and to allow access to the TV game show, according to such status.

Game show play manager module 405 is configured to enable the game server to coordinate and manage the overall television quiz game show play. Game show play manager 405 is configured to sequence the game play provided on the player devices and any user devices. Game show play manager 405, in conjunction with any play control inputs received from the presenter device, may control the timing of the different stages of the game play including the timing and order of questions provided on the devices.

Sudoku player module 406 is configured to provide Sudoku game play on the player devices and any user devices. Team Generator 407 is configured to generate a plurality of teams from the group of selected entrant players. In one example, the team generator is configured to select the plurality of teams by means of a lottery process.

One example of a team leader selector module 408 is shown in FIG. 6. Team leader selector module 600 has a Sudoku play manager 601, a leader selector 602 and a team prize manager 603. Sudoku manager 601 is configured to manage Sudoku play on player devices of each team. Leader selector is configured to select a team leader for each team, according to an outcome of the Sudoku game play by each team. Team prize manager 603 is configured to award a prize to a team, according to the outcome of the Sudoku game play.

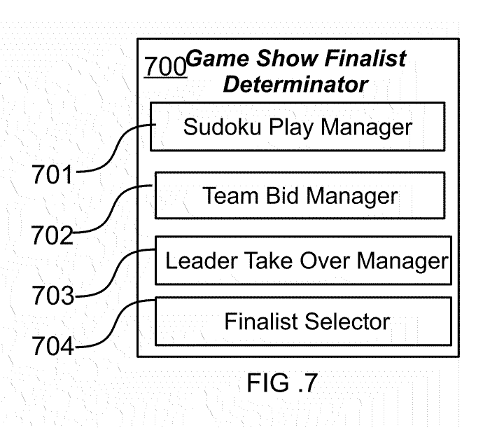

One example of module 409 of FIG. 4 is the game show finalist determinator module detailed in FIG. 7. Game show finalist determinator module 700 has a Sudoku play manager 701, a team bid manger 702, a leader take over manager 703 and a finalist selector 704. Sudoku manager 701 is configured to manage Sudoku game play on the player devices of each team leader. Team bid manager 702 is configured to provide player devices with capability to offer team bids to the finalist player device and to provide the finalist device with the capability to accept the bid according to the finalist selection. Leader take over manager 703 is configured to provide the player devices with functionality through the user application to allow the other team leaders to make a bid to take over the role as finalist in exchange for the team's previously awarded prize being transferred to the finalist. Finalist selector 704 is configured to select a game finalist, according to the outcome of the Sudoku game play by each team leader.

In one non-limiting embodiment, the television studio broadcaster and game show controller device are configured to enable broadcasting/recording of Sudoku game play on player devices 103 in the TV game show to be synchronized with Sudoku game play on the user devices 122,125. The Sudoku game play may have similar or identical aspects to at least part of the Sudoku game play in the TV game show on the player devices and may be separate from the TV game show play or integrated with the TV game show play.

Methods of television quiz show gaming will now be described, according to embodiments.

By way of example, a method of television quiz show gaming, according to one embodiment, implemented in the television game show studio and data processing environment of FIG. 1 will now be explained in more detail. Let us assume that a plurality of users (people) 125 wishing to enter as participants in the game show have registered as applicants online with the TV game show server 101. For example, users may register by opening a browser on their devices and accessing the game show application module over the internet. A user game registration interface is provided on each user device for display by the device browser. Users enter user/registration information through the user game registration interface. The user registration manager 404 of the game show software system stores user registration information received from the user devices in the user database 414 of FIG. 4.

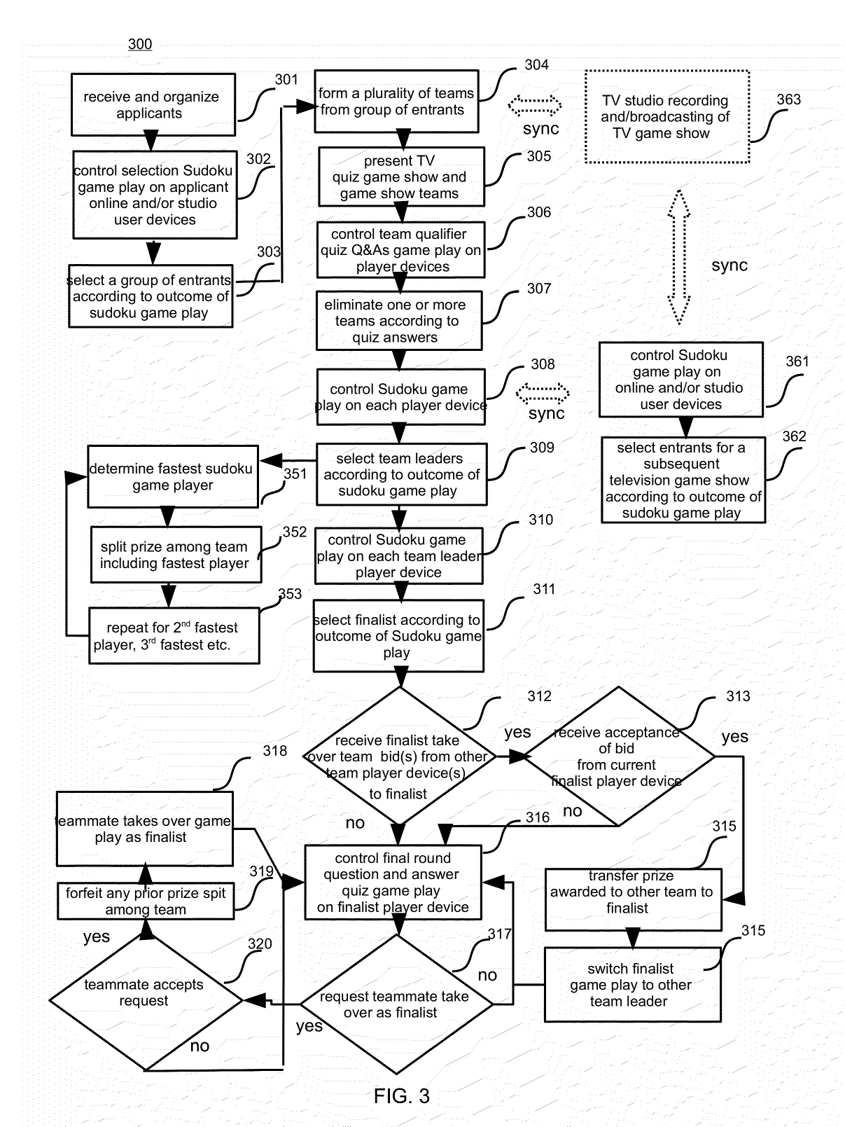

The method of television game show quiz starts by the game show software system 400, for example the player entrant selector 500, arranging registered applicants into manageable groups, such as groups of 50-100 users (301 of FIG. 3). Alternatively, arrangement of applicant into groups can be performed by a person, such as a game administrator, and manually entering information into the game show server.

Game show software system 400 provides a Sudoku game play interface on the user devices of a group of the applicants for display through their browsers (302). The game show software system 400 achieves this for example by game show play manager 405 working in conjunction with player entrant selector 500 to retrieve one or more Sudoku puzzle templates from the Sudoku database for providing the Sudoku game play interface on the user devices. The puzzle templates may be randomly generated or the same for each user device. Each applicant of the group plays the Sudoku game displayed on their user device. In one example, a time limit for solving the Sudoku puzzle is also assigned to the Sudoku game play, and the time remaining for Sudoku game play is provided on the game play interface for display to the user. One non-limiting example of a screen shot of Sudoku game play interface is shown in FIG. 9.

A plurality of game show player entrants is then selected, according to the outcome of the Sudoku game play (303 of FIG. 3). The game show software system 400 achieves this selection by the player entrant selector obtaining from each user device of the group of applicants the solution inputted into the game play user interface for solving the Sudoku game. For each user, the module compares the input solution to a correct solution held in the Sudoku database and also calculates the time it takes for each user device to provide the solution to the Sudoku game. The module determines the fastest Sudoku solution time among the users of the group. In one example, a plurality of users with the fastest solution times among the group of users are selected as game show player entrants. For example, 16 of the users in the group of 50-100 users with the top 16 fastest solution times are selected. Processes 301-304 of FIG. 3 can be performed before broadcasting/recording of the TV game show. Alternatively, processes 301-304 can be performed during broadcasting/recording of the game show. For example, the group of applicants may be seated in the studio audience with their user devices.

The game show software system 400 then forms a plurality of teams from the group of selected player entrants (304 of FIG. 3). For example, in the TV game show implemented in FIG. 1, team generator module 407 generates four teams of four players 105, that is teams A, B, C and D, are selected from a group of 16 selected player entrants. In one example, the team generator 407 can conduct a lottery to organize each team out of the group of players. Formation of a plurality of teams may, alternatively, be implemented by a game administrator and/or game presenter selecting players for each team and then entering this information into the application game server.

As shown in FIG. 1, in one non-limiting example, each team is isolated in their own area, sitting around their “café” table. 150. While seated at the table, team players 105 have access to individual player devices 103 for game play. In other examples, players on the same team may share one or more player devices. The TV game show presenter 106 has access to a presenter device 104 for monitoring and managing game play via the presenter device.

The TV game show presenter presents the TV show game to the studio cameras 108 and any audience 107 of FIG. 1 (305 of FIG. 3). The presenter may introduce the cast and teams and may explain the game show rules.

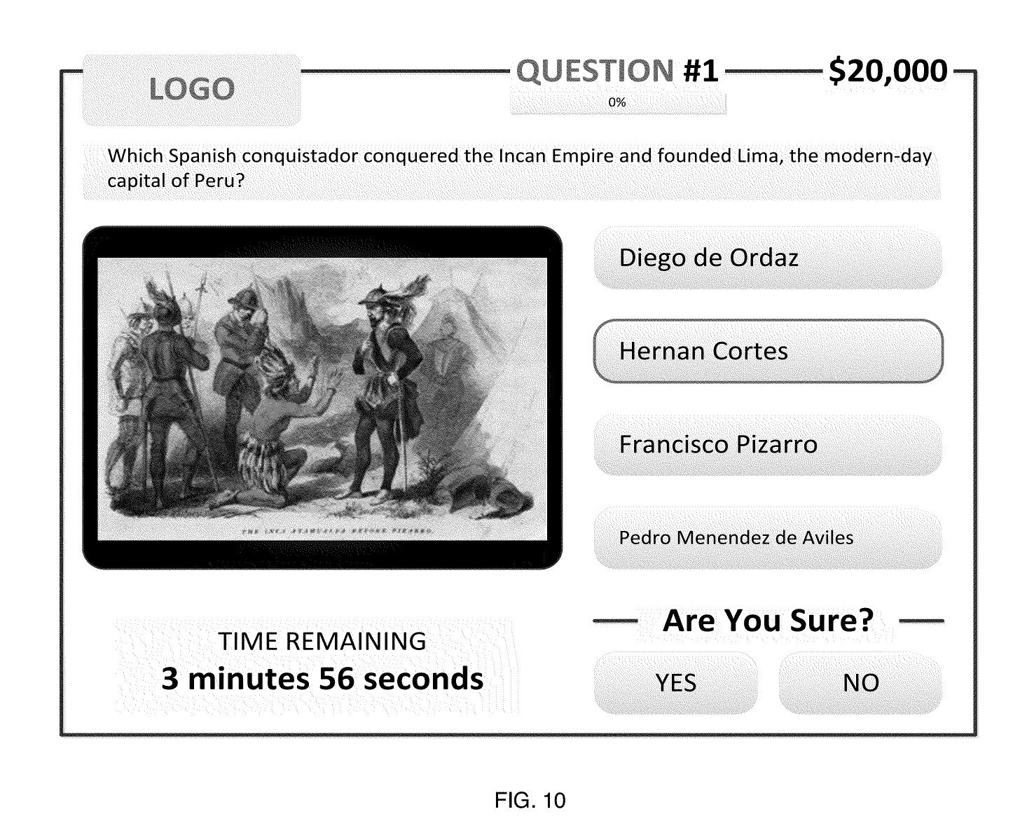

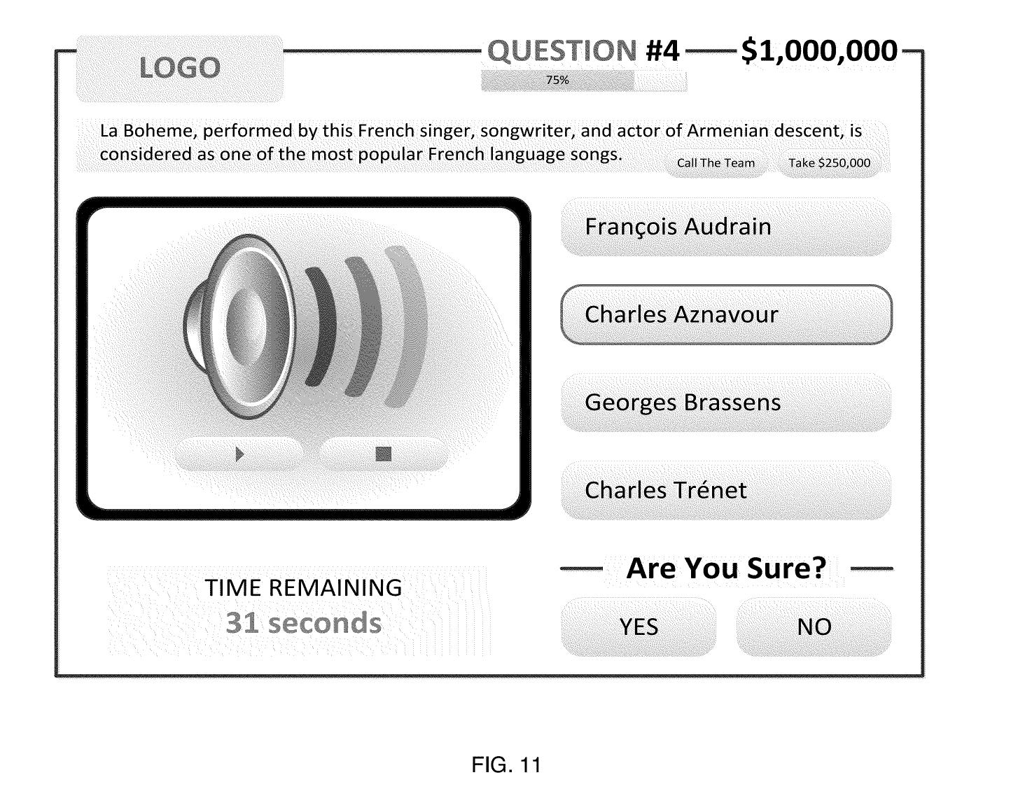

In one example, round one of the game show begins with the team qualifier question being provided to team player devices 103 of FIG. 1 for display to the teams (306 of FIG. 3). Round one is mainly an elimination round to lower the number of players. Non-limiting examples of question and answer quiz game interfaces are shown in FIGS. 10 and 11. Presentation of a question on the player devices 103 may be performed automatically by game show software system 400 after a predetermined time period in response to receiving a presenter question input via the presenter device (for example by the presenter pushing a button). For example, each team is given the same multiple-choice question, but each player can answer the question separately. In another example, each team is given a different question to answer. Discussion may take place among the group. The software system 400 receives from the team player devices answer inputs entered by the team players for answering the questions and compares these to correct answers stored in the quiz database. In another example, answers from the team players may be given to the presenter and entered into the presenter player device by the presenter for communication to the game server for comparing to the correct answers.

Team qualifier question and answer game play includes providing a time limit for answering the question (306 of FIG. 3). In one example, the team players 105 of FIG. 1 have four minutes to answer the question. The remaining time for answering the question may be included in the question interface for display on the team player devices.

If software system 400 determines that an answer presented by a player is incorrect, the module eliminates that player from the game play (307 of FIG. 3). If every player of a team answers incorrectly, then that team is eliminated and the game will continue with the other teams. In one example, team qualifier question and answer play can involve presenting a series of questions until all players of one team are eliminated. For example, if game play begins with four teams of four players, the remaining three teams will continue game play when one team is eliminated.

Game play then proceeds to round two. The software system 400 provides a Sudoku game play interface on each of the player devices of the remaining players for enabling Sudoku game play through the remaining player devices (308 of FIG. 3). This next challenge is to determine who becomes the leader of each of the remaining teams (309 of FIG. 3). Each remaining player from each team plays a game of Sudoku on his or her player device. The Sudoku game play is managed by for example the team leader selector module 600 in a way similar to the aforementioned Sudoku game play is managed for player entrant selection. The time limit for solving the Sudoku puzzle may be, for example, four minutes. Whichever remaining player finishes first from their team is the team leader. Team leader selector module 600 achieves this by determining for each team the fastest solution time among the players on the team and then automatically designates the fastest player on the team as team leader for future game play (309 of FIG. 3).

As an added bonus, whichever one of the remaining players solves the Sudoku game first in time receives a cash prize for their team that will be divided evenly among all the members of that team. Game show software system 400, such as team prize manager 603, determines from the solution times of all the team players which player among the remaining players of the teams has the fastest Sudoku game solution time (351 of FIG. 3). Game show software system 400 then determines the prize award and team associated with the fastest solution time and splits this award among the team players. Software system may send an award notification to the player devices of the team confirming that the players have received and shared the prize. In one example, software system 400 may manage banking transactions in which funds matching the prize amounts for each player are electronically transferred into the bank accounts of the players. In another example, the application module may send a redeemable award to each player. Processes 351-352 (FIG. 3) may be repeated for the next fastest player (353), for example, game show software system 400 determines the prize award associated with the next fastest solution time and splits this prize award equally or otherwise among the team of the player with the next fastest solution. In the example of FIG. 1 in which there are 4 teams of four players, this process is repeated for the second, third, and fourth fastest players among all the 16 players. Examples of prize awards follow: first fastest $15,000; second fastest $10,000, third fastest $7,500, and fourth fastest $5,000

Game play in round three proceeds for the selected team leaders. The game show finalist selector module 409 manages a Sudoku game play interface on each of the team leader player device (310 of FIG. 3). The time limit for solving the Sudoku puzzle may be, for example, four minutes. The finalist is selected according to the outcome of the Sudoku game play (311 of FIG. 3). For example, whichever team leader finishes first among the selected team leaders is designated the game finalist. In one example, game show finalist determinator module 700 does this by determining the fastest solution time among the team leaders and automatically designating the fastest player as finalist for final round game play. In another example, the Sudoku game play can include a series of Sudoku puzzles, and the team leader player winning the most Sudoku games or with the best overall time score can be selected as the finalist.

In one example, after the finalist person is determined and before continuing game play, take over bids from one or more teams wishing to take over the role of the finalist may be provided to the finalist for consideration. For example, team bid manager 702 of game show finalist determinator module 700 implements this finalist take over bidding by providing a bid offer interface to the player devices of the teams for enabling the teams to place a bid to take over game play in exchange for cash or other prize offers from the team (312 of FIG. 3). A corresponding bid acceptance interface is provided to the finalist player device for enabling the finalist to accept or reject a particular bid. In one embodiment, only teams that have been awarded a prize in round two may bid and the bid is automatically set at the price awarded to the team in round two. Each team bid is received by the team bid manager module through the bid interface provided on a team player device and the application module presents each bid to the finalist player device. The finalist enters a bid acceptance or bid rejection input through the bid interface provided on the finalist player device, and the application module acts on the input accordingly. Alternatively, the presenter enters in the presenter device acceptance or rejection on behalf of the finalist.

If the finalist accepts a team bid to take over his role, the leader of the team offering the bid accepted by the finalist takes over the role of finalist (313 of FIG. 3). In one example, leader take over manager module 703 implements this finalist take over in response to the bid acceptance input from the finalist (313 of FIG. 3), by determining the team leader of the team offering the bid accepted by the finalist, switching over the final round game play to the player device of the take over team leader (315 of FIG. 3), and transferring the team prize awarded in round two to the finalist (314 of FIG. 3). If the finalist does not accept any bids (313 of FIG. 3), the original finalist continues to the final round of the game.

Game play in the final round then proceeds for the finalist player (316 of FIG. 3). In one example, the final round of the game show is a quiz question and answer game play in which a series of questions have to be answered correctly to win the game. The software system 400 provides the team quiz game play interface on the finalist player device. A time limit for answering the question is determined by the software system 400. In one example, the finalist player has four minutes to answer the question. The remaining time for answering the question may be included in the question interface for display on the finalist player device. Software system 400 receives from the finalist player device an answer input for answering the question and compares this to the correct answer stored in the quiz database.

In one example, the quiz game play in the final round includes a series of questions, and each question is associated with a set prize amount, which is awarded to the finalist for answering the question correctly. For example, there may be 4 questions with associated prize awards as follows: Question 1 $20,000; Question 2 100,000; Question 3 $250,000; and Question 4 $1,000,000

The finalist has the option to walk away with his prize winnings before answering each question, but the prizes awarded to the finalist are then automatically shared among the team of the finalist. If the player gets to a question that he or she cannot answer and declines to answer, the finalist has the opportunity to give up his/her spot to one of his teammates; but in doing so, the finalist team will lose any prizes awarded in round two. When deciding which teammate should take over the role of finalist, the finalist cannot discuss this with the team and make a choice based on intuition when each of his team mates are separated and sitting alone in the final round

When reaching the final question, for example, the million-dollar question, the finalist has the option to involve his team to make a group decision or answer the question alone. In the event of answering the question alone, the finalist is awarded the entire final price for answering the final question. However, if the team answers the final question together, the final prize is split equally among the team.

Method 300 demonstrates an approach in which one or more player selections in a television question and answer quiz show game play are made according to a Sudoku game play on player and/or user devices. The television game quiz show controller device may automatically make one or more of the player selections for entering or continuing in the game show, according to the outcome of the Sudoku game play on the devices. Examples of such player selections in method 300 come from the initial selection of a player from entrants, a selection of a player to a subsequent round of the game show, a selection of a player of each team as team leader, and a selection of a team leader as finalist in the final round of the game show.

By utilizing the television game show controller device and providing a Sudoku game play on the player and/or user devices, making one or more of player selections for entering or continuing in the television question and answering quiz game show, according to the outcome of the Sudoku game play on the devices, a unique player selection process is provided based on Sudoku logic rather than general knowledge.

According to an example of the method 300 shown in FIG. 3, broadcasting/recording of Sudoku game play on studio player devices (363) for any one or combination of player selection, team leader selection, and finalist selection during the television question and answer quiz game show can be substantially synchronized with Sudoku game play on user devices (see 361) for player selection for another television question and answer quiz game in the future (362). These user devices for player selection for a subsequent television question and answer game show may be user devices of remote users, including users viewing the broadcasting of the television game show and/or users in the studio audience.

In one example, the television game show controller device may provide Sudoku game play conditions on the user devices for play selection for a subsequent television game, which are the same or generally similar to the Sudoku game play conditions provided on the player devices in the player selection process for the current television question and answer quiz game. For example, Sudoku game play templates provided on both the player devices and user devices can be randomly generated on each device such that each player and user has to solve a different Sudoku puzzle. Alternatively, the Sudoku game play templates provided on both the player devices and user devices can be the same on each device such that each player and user has to solve the same Sudoku puzzle.

By substantially synchronizing broadcasting/recording of Sudoku game play on studio player devices for player selection in the television question and answer quiz game with Sudoku game play on user devices for player selection for a subsequent Television question and answer quiz game, remote users and/or audience users playing the Sudoku game play on the user devices for player selection in a subsequent TV game show have a unique and exciting player selection gaming experience because they are aware that they are playing the Sudoku game during broadcasting/recording of the same or similar Sudoku play in the television game show. Furthermore, users that have access to view the television game show on television have an even more exciting experience because those users can compare their outcome of their Sudoku game play with that of the outcome of the Sudoku game play being broadcast/recorded on television at substantially the same time.

The television game show controller can determine the fastest Sudoku solution times of the Sudoku game play among player devices for player selection in the current television game show. The television game show controller device can also determine the fastest Sudoku solution times among users of user devices for player selection for a subsequent game show. The television game show controller can also determine the fastest Sudoku solution times among both the player devices for player selection in the TV game show and among user devices for player selection in a subsequent TV game show. The television game show controller can select the player or user with the fastest Sudoku time and communicate this to the presenter/host and/or selected player or user. The player or user with the fastest Sudoku time may be announced on the TV game show. Furthermore, a prize may be awarded to the player or user with the fastest time. In this manner, the audience, TV viewers of the game, players and users have a unique and exciting experience as a result of the Sudoku game play for player selection among players in the current TV game show being substantially concurrent or integrated with Sudoku play for subsequent TV game show player selection among users in the studio audience or remote from the studio.

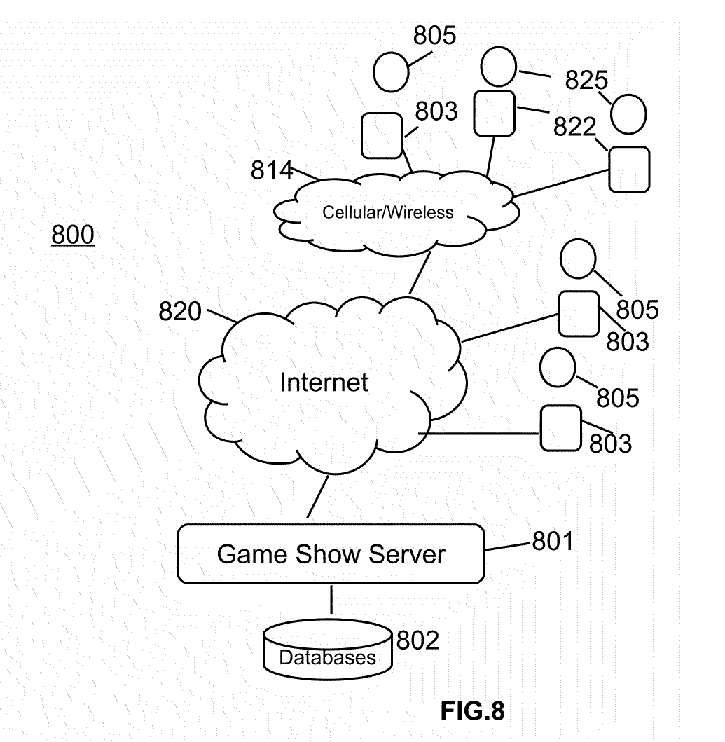

FIG. 8 is a schematic of an exemplary data processing network environment in which methods of internet quiz show gaming may be implemented, according to another embodiment. In this example, the game show server 801, the database 802, the player devices 803 of the players 805, and the user devices 822 of the game applicants 825 are internetworked via the internet 320 to form an internet quiz question and answer game show system 800. In this example, functionality that would normally be performed in the TV studio is performed by the game show internet system or maybe omitted. For example, internet game show system 800 may implement a method similar to game show method of FIG. 3 but in which TV studio related method processes such as presentation of the game show (305), broadcasting and recording, and synchronization thereof with Sudoku game play are implemented entirely in an internet environment rather than a TV studio environment.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

What is claimed is:

1. A method of television quiz show gaming comprises:
controlling, utilizing a television quiz game show controller device, a television quiz question and answer game play on player devices of a plurality of players;
controlling, utilizing said game show controller device, at least one Sudoku game play on at least some of said player devices; and
selecting, utilizing said game show controller device, at least one player from among said plurality of players for entering or continuing to play in said television quiz question and answer game show according to the outcome of said Sudoku game play on said player devices.

2. The method of claim 1, wherein controlling, utilizing a television quiz game show controller, a quiz question and answer game play on player devices of a plurality of players comprises:
controlling, utilizing the game show device, a team qualifier question and answer quiz game play on each player device of a plurality of teams; and
eliminating, utilizing said game show device, at least one of said teams from game show play according to an outcome of said team qualifier quiz play.

3. The method of claim 2, wherein controlling, utilizing said game show device, at least one Sudoku game play on at least some of said player devices further comprises:
controlling, utilizing said game show device, a Sudoku game play on each player device of the remaining team players; and
wherein selecting, utilizing said game show device, at least one player from among said plurality of players for entering or continuing to play in said television quiz question and answer game show comprises:
selecting, utilizing said game show device, a team leader of each team according to an outcome of said Sudoku game play on each remaining team player device.

4. The method of claim 3, further comprises:
determining, utilizing said game show device, at least one fastest Sudoku game player from the outcome of said Sudoku game play for selecting said team leaders; and
splitting at least one prize among players of at least one team of said at least one fastest Sudoku game player.

5. The method of claim 4, wherein controlling, utilizing said game show device, at least one Sudoku game play on at least some of said player devices further comprises:
controlling, utilizing said game show device, a Sudoku game play on each player device of the selected team leaders; and
wherein selecting, utilizing said game show device, at least one player from among said plurality of players for entering or continuing to play in said television quiz question and answer game show further comprises:
selecting, utilizing said game show device, a finalist to play in a final round of question and answer game show play, according to the outcome of said Sudoku game play on each player device of the selected team leaders.

6. The method of claim 5, further comprises:
receiving in said game device, at least one team bid for a team leader of another team to take over game play as said finalist;
in response to receiving in said game device, a request from said finalist player device to accept said team bid, transferring any price previously split among said another team to said finalist, and switching over the final round question and answer quiz game play to the player device of the team leader of the another team.

7. The method of claim 5, wherein controlling, utilizing a television quiz game show controller device, a quiz question and answer game play on player devices of a plurality of players further comprises:
controlling, utilizing said game show device, a final round question and answer quiz game play on the finalist player device; and
awarding, utilizing said game show device, at least one game show prize to the finalist, according to an outcome of at least part of said final round quiz game play.

8. The method of claim 7, further comprises:
receiving in said game device, a finalist request for a selected teammate to take over game play;
in response to receiving in said game device, an acceptance input from said selected teammate, switching over the final round question and answer quiz game play to the player device of said selected teammate and retracting any game price previously split among said finalist team.

9. The method of claim 1, further comprises:
television recording and/or television broadcasting said TV game show play on said player devices;
controlling, utilizing said game show device, a Sudoku game play on internet user devices and/or studio audience user devices of applicants applying to be players in a subsequent television game show;
selecting, utilizing said game show device, subsequent television game show quiz players from said plurality of applicants, according to the outcome of said applicant selection Sudoku game play on said user devices; and
substantially synchronizing said television recording and/or broadcasting of said game play by said players with said Sudoku game play by said applicants on said user devices.

10. The method of claim 9, wherein substantially synchronizing television broadcasting of Sudoku game play by said players with Sudoku game play on said user devices of said applicants applying to be players in a subsequent television game show further comprises:
substantially synchronizing television broadcasting of said Sudoku game play on said player devices with said Sudoku game play on said user devices of said applicants, such that applicants applying to enter the subsequent game show can play a Sudoku game substantially at the same time as said broadcasting of said Sudoku game play on said player devices in said television game show.

11. An apparatus for a television quiz game show, said apparatus comprises:
a processor operably connectable to at plurality of player devices;
a data bus coupled to said processor;
a computer-usable medium embodying computer program code, said computer-usable medium being coupled to said data bus; and
said computer program code comprising instructions executable by said processor and configured for:
controlling a television quiz question and answering game play on player devices of a plurality of players;
controlling at least one Sudoku game play on at least some of said player devices; and
selecting at least one player from among said plurality of players for entering or continuing to play in said television quiz question; and
answer game show, according to the outcome of said Sudoku game play on said player devices.

12. The apparatus of claim 11, wherein said computer program code comprises further instructions executable by said processor and configured for:
controlling a team qualifier question and answer quiz game play on each player device of a plurality of teams; and
eliminating at least one of said teams from game show play, according to an outcome of said team qualifier quiz play.

13. The apparatus of claim 12, wherein said computer program code comprises further instructions executable by said processor and configured for:
controlling a Sudoku game play on each player device of the remaining team players; and
selecting a team leader of each team, according to an outcome of said Sudoku game play on each remaining team player device.

14. A computer-usable medium for a television quiz game show, said computer-usable medium embodying computer program code, said computer program code comprises computer executable instructions configured for:
controlling, utilizing a television quiz game show controller device, a television quiz question and answer game play on player devices of a plurality of players;
controlling, utilizing said game show controller device, at least one Sudoku game play on at least some of said player devices; and
selecting, utilizing said game show controller device, at least one player from among said plurality of players for entering or continuing to play in said television quiz question and answer game show, according to the outcome of said Sudoku game play on said player devices.

15. The medium of claim 14, said computer program code comprising computer executable instructions is further configured for:
controlling, utilizing said game show controller device, a team qualifier question and answer quiz game play on each player device of plurality of teams; and
eliminating, utilizing said game show controller device, at least one of said teams from said game show play, according to an outcome of said team qualifier question and answer quiz play.

16. The medium of claim 15, said computer program code comprising computer executable instructions configured for:
controlling, utilizing said game show controller device, a Sudoku game play on each player device of the remaining team players; and
selecting, utilizing said game show controller device, at least one player from among said plurality of players for entering or continuing to play in said television quiz question and answer game show comprises:
selecting, utilizing said game show controller device, a team leader of each team, according to an outcome of said Sudoku game play on each remaining team player device.
